(19) United States
(12) Patent Application Publication
(10) Pub. No.: US 2026/0322508 A1
(43) Pub. Date: Oct. 15, 2026

(54) DETECTION OF CHANGE OF ORIENTATION OF AAS

(71) Applicant: Telefonaktiebolaget LM Ericsson (publ), Stockholm (SE)

(72) Inventors: Christer ENGDAHL, Särö (SE); Lars PERSSON, Åsa (SE); Torbjörn ELFSTRÖM, Fjärås (SE); Bhushan BILLADE, Lindome (SE)

(73) Assignee: Telefonaktiebolaget LM Ericsson (publ), Stockholm (SE)

(21) Appl. No.: 19/481,295

(22) PCT Filed: May 5, 2023
(86) PCT No.: PCT/EP2023/061920

§ 371 Date: Nov. 4, 2025

(51) Int. Cl. H04B 17/18

(52) U.S. Cl. CPC H04B 17/18

(57) ABSTRACT

There is provided techniques for detecting a change in orientation of an AAS of a second network node. A method is performed by a first network node. The second network node and the first network node are operating in a TDD system with a slot structure composed of DL slots, UL slots, and flexible slots. The method comprises a monitoring process. The monitoring process comprises receiving, in one of the flexible slots and from the second network node, a test signal. Receiving the test signal involves estimating a characteristic spatial signature of the test signal. The monitoring process comprises issuing a notification of change of orientation of the AAS of the second network node when the estimated characteristic spatial signature of the test signal fails to fulfil a matching criterion with respect to a reference characteristic spatial signature of the test signal.

### TECHNICAL FIELD

Embodiments presented herein relate to methods, network nodes, computer program, and a computer program product for detecting a change in orientation of an Active Antenna System of one of the network nodes.

### BACKGROUND

The New Radio (NR) air interface as part of the fifth generation (5G) telecommunication system provides enhancements of the electromagnetic radiation spectrum efficiency for mobile broadband. This is for example achieved by the NR air interface supporting a large carrier bandwidth together network equipment, such as transmission and reception points, or other types of network nodes, being equipped with Active Antenna Systems (AASs).

For the operation of the telecommunication system to be as good as possible, and to reduce the risk of the telecommunication system causing interference, or other types of disturbances, to other wireless communication systems, radar systems, satellite systems, etc. the orientation of the AASs should be controlled. This could particularly be the case to ensure that AASs fulfill regulatory requirements for co-existence with aviation and satellite systems.

Some examples of existing technology for controlling the orientation of the AASs will be disclosed next.

According to one example, maintenance personnel are sent out to visit the sites at which the AASs are installed in the field to manually measure the AAS orientation, using for example spirit-level and compass equipment. This can in many cases be costly, not the least because some sites are in hard-to-reach places. An alternative is to use some type of aerial vehicle, such as an unmanned aerial vehicle, to visit the site. But this requires additional dedicated equipment (in terms of the aerial vehicle), as well as supervising and controlling the aerial vehicle, including preparations, etc.

According to another example some satellite navigation system, such as a Global Navigation Satellite System (GNSS) is used to keep track of the AAS orientation. However, this requires each AAS to be equipped with a satellite navigation receiver. In turn, this not only increases the size of the AAS but also the power consumption of the AAS for operating the satellite navigation receiver. Still further, reception of satellite signals at the satellite navigation receiver might be susceptible to interference from other network nodes operating at neighboring frequencies as well as from the AAS itself where the satellite navigation receiver is installed.

Hence, there is still a need for efficient control of the orientation of AASs as used in telecommunication systems.

### SUMMARY

An object of embodiments herein is to address the above issues.

A particular object is to provide efficient control of the orientation of AASs without requiring the use of maintenance personnel, or additional dedicated equipment (such as aerial vehicles or satellite navigation receivers).

According to a first aspect there is presented a method for detecting a change in orientation of an AAS of a second network node. The method is performed by a first network node. The second network node and the first network node are operating in a Time-Division Duplex system with a slot structure composed of DL slots, UL slots, and flexible slots. The method comprises a monitoring process. The monitoring process comprises receiving, in one of the flexible slots and from the second network node, a test signal. Receiving the test signal involves estimating a characteristic spatial signature of the test signal. The monitoring process comprises issuing a notification of change of orientation of the AAS of the second network node when the estimated characteristic spatial signature of the test signal fails to fulfil a matching criterion with respect to a reference characteristic spatial signature of the test signal.

According to a second aspect there is presented a first network node for detecting a change in orientation of an AAS of a second network node. The method is performed by a first network node. The second network node and the first network node are operating in a Time-Division Duplex system with a slot structure composed of DL slots, UL slots, and flexible slots. The first network node comprises processing circuitry. The processing circuitry is configured to cause the first network node to receive, in one of the flexible slots and from the second network node, a test signal. Receiving the test signal involves estimating a characteristic spatial signature of the test signal. The processing circuitry is configured to cause the first network node to issue a notification of change of orientation of the AAS of the second network node when the estimated characteristic spatial signature of the test signal fails to fulfil a matching criterion with respect to a reference characteristic spatial signature of the test signal.

According to a third aspect there is presented a first network node for detecting a change in orientation of an AAS of a second network node. The method is performed by a first network node. The second network node and the first network node are operating in a Time-Division Duplex system with a slot structure composed of DL slots, UL slots, and flexible slots. The first network node comprises a receive module configured to receive, in one of the flexible slots and from the second network node, a test signal. Receiving the test signal involves estimating a characteristic spatial signature of the test signal. The first network node comprises an issue module configured to issue a notification of change of orientation of the AAS of the second network node when the estimated characteristic spatial signature of the test signal fails to fulfil a matching criterion with respect to a reference characteristic spatial signature of the test signal.

According to a fourth aspect there is presented a computer program for detecting a change in orientation of an AAS of a second network node. The computer program comprises computer code which, when run on processing circuitry of a first network node, causes the first network node to perform actions. One action comprises the first network node to receive, in one of the flexible slots and from the second network node, a test signal. Receiving the test signal involves estimating a characteristic spatial signature of the test signal. One action comprises the first network node to issue a notification of change of orientation of the AAS of the second network node when the estimated characteristic spatial signature of the test signal fails to fulfil a matching criterion with respect to a reference characteristic spatial signature of the test signal.

According to a fifth aspect there is presented a method for detecting a change in orientation of an AAS of a second network node. The method is performed by the second network node. The second network node and a first network node are operating in a Time-Division Duplex system with a slot structure composed of DL slots, UL slots, and flexible slots. The method comprises a monitoring process. The monitoring process comprises transmitting, via the AAS and in one of the flexible slots, a test signal. The monitoring process comprises receiving a notification of change of orientation of the AAS of the second network node when estimated characteristic spatial signature of the test signal fails to fulfil a matching criterion with respect to a reference characteristic spatial signature of the test signal.

According to a sixth aspect there is presented a second network node for detecting a change in orientation of an AAS of the second network node. The second network node and a first network node are operating in a Time-Division Duplex system with a slot structure composed of DL slots, UL slots, and flexible slots. The second network node comprises processing circuitry. The processing circuitry is configured to cause the second network node to transmit, via the AAS and in one of the flexible slots, a test signal. The processing circuitry is configured to cause the second network node to receive a notification of change of orientation of the AAS of the second network node when estimated characteristic spatial signature of the test signal fails to fulfil a matching criterion with respect to a reference characteristic spatial signature of the test signal.

According to a seventh aspect there is presented a second network node for detecting a change in orientation of an AAS of the second network node. The second network node and a first network node are operating in a Time-Division Duplex system with a slot structure composed of DL slots, UL slots, and flexible slots. The second network node comprises a transmit module configured to transmit, via the AAS and in one of the flexible slots, a test signal. The second network node comprises a receive module configured to receive a notification of change of orientation of the AAS of the second network node when estimated characteristic spatial signature of the test signal fails to fulfil a matching criterion with respect to a reference characteristic spatial signature of the test signal.

According to an eighth aspect there is presented a computer program for detecting a change in orientation of an AAS of a second network node. The computer program comprises computer code which, when run on processing circuitry of the second network node, causes the second network node to perform actions. One action comprises the second network node to transmit, via the AAS and in one of the flexible slots, a test signal. One action comprises the second network node to receive a notification of change of orientation of the AAS of the second network node when estimated characteristic spatial signature of the test signal fails to fulfil a matching criterion with respect to a reference characteristic spatial signature of the test signal.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide efficient control of the orientation of AASs.

Advantageously, these aspects do not require the use of maintenance personnel, or additional dedicated equipment (such as aerial vehicles or satellite navigation receivers).

Advantageously, these aspects enable the network, comprising the network nodes, to monitor itself with respect to antenna orientation. Advantageously, this is enabled without visual inspection or in-field measurements using dedicated measurement equipment.

Advantageously, if the monitoring is performed during occasions with low traffic load (e.g., during night), the monitoring will only have negligible impact on network traffic and hence not on network performance.

Advantageously, the orientation of the AAS of the second network node can be checked by multiple neighboring first network nodes, and vice versa.

Advantageously, reliability and robustness of the proposed aspects can be improved by using more than one first network node to monitor the second network node.

Advantageously, the herein disclosed aspects do not require line-of-sight conditions between the involved network nodes. In this way, the number of possible network nodes that can be involved to monitor each other can be increased.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a schematic illustration of a set of transmit beams and a receive beam according to embodiments;

FIGS. 3, 4, 5, and 6 are flowcharts of methods according to embodiments;

FIGS. 7 and 8 show examples of received signal power as function of transmitted beam direction according to an embodiment;

FIG. 9 is a schematic illustration of the estimated shift of the orientation of an AAS according to an embodiment;

FIG. 10 is a schematic illustration of how estimations of the rotation of one AAS changes over time according to an embodiment;

FIG. 11 is a schematic diagram showing functional units of a network node according to an embodiment;

FIG. 12 is a schematic diagram showing functional modules of a network node according to an embodiment; and

FIG. 13 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, there is still a need for efficient control of the orientation of AASs as used in telecommunication systems.

Both Frequency Division Duplex (FDD) and Time-Division Duplex (TDD) operation are supported in NR based telecommunication systems, with operation occurring in a spectrum ranging from 410 MHz to 71 GHz. In turn, the spectrum is divided into two ranges, denoted FR1 and FR2, with an intermediate range from 7 to 24 GHz where no frequency bands are defined.

TDD refers to duplex communication links where uplink is separated from downlink by the allocation of different time slots in the same frequency band. It is a transmission scheme that allows asymmetric flow for uplink and downlink data transmission. This is achieved by using different TDD patterns. Served user equipment (UEs) are allocated time slots for uplink and downlink transmission. Time division multiplexing separates uplink and downlink signals by matching full duplex communication over a half-duplex communication link. TDD is highly advantageous in case there is an asymmetry with respect to uplink and downlink data rates. When TDD is used, a data stream is divided into frames and different time slots are assigned to the downlink and uplink transmissions, thereby allowing both downlink and uplink transmissions to share the same transmission medium.

For FDD operation, on the other hand, the communication is split between two dedicated frequency channels.

This makes it complex (e.g., requiring dual-paired duplex filters) to allow the network to supervise itself. However, for telecommunication system using TDD operation it would be possible to let the network nodes listen to wireless transmissions from other network nodes by changing the TDD pattern.

Different TDD patterns are defined by how each of the symbols within a single slot is used. Different TDD patterns can be indicated by the slot format that accordingly defines which symbols are used for uplink and which symbols are used for downlink within a specific slot. In NR based telecommunication systems, the symbols within a slot can be configured in various ways. This is since there is no need to use every symbol within a slot. A single slot can be divided into multiple segments of consecutive symbols that can be used for uplink, downlink or be flexible.

Theoretically, there could be almost an infinite number of possible combinations of downlink symbols, uplink symbol, and flexible symbols within a slot. In 3GPP TS 38.213 “NR; Physical layer procedures for control”, version 17.5.0, Table 11.1.1-1, no more than 61 predefined symbol combinations within a slot are defined.

One reason for having different TDD patterns is to make scheduling flexible, especially for TDD operation. By applying a slot format, or combining different slot formats in sequence, various different types of scheduling options can be implemented. With such dynamic TDD operation enabled, the uplink and downlink transmissions can be dynamically scheduled to adapt to actual traffic mix and network load. However, this requires coordination between different network nodes to avoid interference between cells. Such coordination can be difficult to achieve in networks with many network nodes.

Hereinafter are described techniques to utilize the NR flexibility with respect to dynamic TDD slot allocation in conjunction with AAS technology to supervise network aspects, such as AAS orientation. By evaluating network characteristics, network coverage, AAS location and orientation, etc. can be monitored by the network itself without any need for additional dedicated monitoring equipment.

The herein described techniques are based on using flexible slots to schedule a BS-to-BS transmission (i.e., a transmission from one network node to another network node) in the uplink for one network node within the network. Then this network node can listen in the flexible slot for transmissions scheduled by other network nodes within the network. The flexible slot that is used in this manner can thus be referred to as a monitoring slot. By dynamically changing the usage of the monitoring slot within the network, all network nodes within the network can monitor one or more of its close neighbor network nodes, possibly including some of its closest neighbor network nodes.

In summary, and as will be disclosed in further detail below, dynamically changed TDD patterns can be utilized for monitoring the AAS orientation in cellular telecommunication systems. A first network node can be configured to, in a flexible slot, listen for transmission from a second network nodes. This enables the first network node to measure signal parameters of the second network nodes. The transmission is associated with a characteristic spatial signature, such as beam pattern, that can be evaluated by the first network node. The evaluation can reveal if the orientation of the AAS at the second network node has changed or not, and any deviation in orientation can be logged, or an alarm can be raised, if deemed necessary. By changing roles between which network node acts as the first network node and which network node that acts as the second network node, all network nodes in the network can monitored. This allows for an extensive overview of the AAS orientation status.

In an optional initialization process, the characteristic spatial signature of each network node to be monitored can be measured and stored right after deployment of the network node and the AAS having been correctly installed, or right after the AAS orientation has been confidently checked to be correct. The characteristic spatial signature for the specific AAS can then be measured by one or more network nodes the vicinity (not necessarily in line-of-sight). The measured characteristic spatial signatures can be stored in a network monitoring system.

When at a later point in time the orientation of an AAS needs to be checked, the characteristic spatial signature of the AAS can again be evaluated. By applying a comparison operation on the characteristic spatial signatures from the initialization process and the monitoring process for each transmitting and receiving AAS pair, a change of orientation of the monitored AAS can be detected.

The embodiments disclosed herein in particular relate to techniques for detecting a change in orientation of an AAS of a network node.

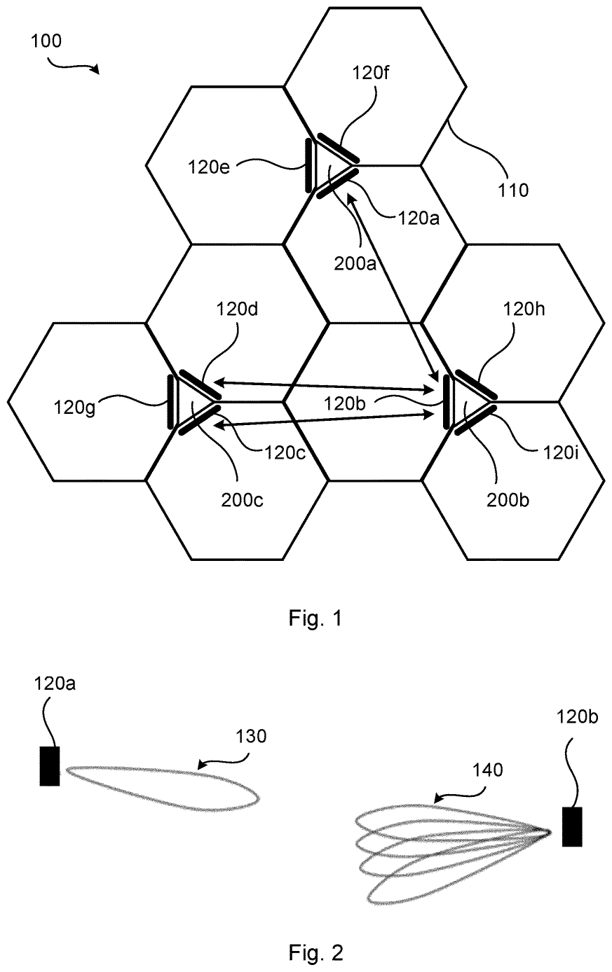

FIG. 1 is a schematic diagram illustrating a communications network 100 where embodiments presented herein can be applied. In some aspects, TDD operation is used in the communications network 100, and the communications network 100 can therefore be referred to as a TDD system 100.

The communications network 100 comprises network nodes 200a, 200b, 200c. Each network node 200a, 200b, 200c is equipped with one or more AAS 120a:120i and is configured to provide network access, or coverage, in a respective cell 110, and thus to serve user equipment. In the illustrative example of FIG. 1, each cell is composed of three sectors. In the illustrative example of FIG. 1, each network node is equipped with three AASs, with a separation in boresight direction of 120 degrees, such that each AASs of a given network node is used to provide network access, or coverage, in a respective cell sector. Each network node could be a (radio) access network node, radio base station, base transceiver station, node B (NB), evolved node B (eNB), gNB, access point, access node, transmission and reception point, integrated access and backhaul node, or the like.

As in the illustrative example of FIG. 1, the network nodes can be organized in the geography to provide coverage and capacity in a given geographical area. Depending on the deployment scenario, neighboring network nodes may be able to communicate with each other via a Line Of Sight (LOS) path, while in urban environments the path between two neighboring network nodes is better described as a non-LOS path. It can be shown that even though two network nodes do not have a direct LOS path, the antenna orientation of these network nodes can still be evaluated.

In the illustrative example of FIG. 1, network node 200b is configured to use AAS 120b to communicate with and AAS 120a of network node 200a as well as AAS 120c and AAS 120d of network node 200c. In this way, AAS 120b is denoted equipment under test (EUT) whereas AASs 120a, 12cd, 120d are denoted evaluating equipment (EE). The roles of the EUT and EE can be scheduled to change until all AAS in the network have been monitored.

This means that EUT can be evaluated by many other EEs. This provides a robust and accurate estimation of the orientation of the AAS of the EUT. The number of EE to be used for monitoring each EUT may depends on radio propagation conditions and network deployment properties. In some examples, the scheduling is managed by a network management system. In some examples, the monitoring is performed either during low traffic or by request.

As will be further disclosed below, during the monitoring process, the EUT transmits a test signal that is received by one or more EEs. As will also be further disclosed below, the test signal might be transmitted in a set of transmit beams, with, for example, one or more occurrence of the test signal being transmitted in each transmit beam. In other words, the test signal might be transmitted in different transmission beams that are steered in different directions during the process. In FIG. 2 is illustrated an AAS 120b configured to transmit a test signal in a set of transmit beams 140 and an AAS 120a configured to receive the test signal in a receive beam 130. It is here noted that the test signal alternatively might be received in a set of receive beams at AAS 120a.

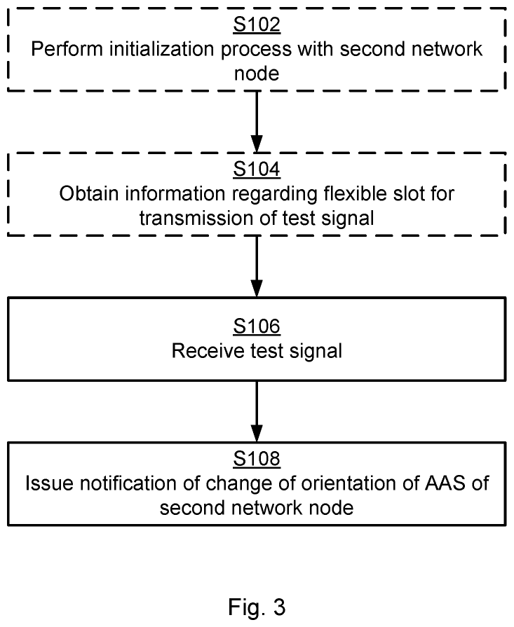

Reference is now made to FIG. 3 illustrating a method for detecting a change in orientation of an AAS 120b of a second network node 200b as performed by the first network node 200a according to an embodiment. The second network node 200b and the first network node 200a are operating in a TDD system 100 with a slot structure composed of DL slots, UL slots, and flexible slots.

The first network node 200a performs a monitoring process. Details of the monitoring process will be disclosed next.

S106: The first network node 200a receives, in one of the flexible slots and from the second network node 200b, a test signal. Receiving the test signal involves estimating a characteristic spatial signature of the test signal.

S108: The first network node 200a issues a notification of change of orientation of the AAS 120b of the second network node 200b when the estimated characteristic spatial signature of the test signal fails to fulfil a matching criterion with respect to a reference characteristic spatial signature of the test signal.

Hence, proposed method utilizes the fact that between the network nodes, the first network node in receiving mode and the second network node in transmitting mode, a unique characteristic spatial signature of the AAS of the second network node can be detected at the first network node over time while beam sweeping is performed at the AAS of the second network node along a certain angular range.

In the proposed method the availability of a dynamic TDD mode is exploited. in the sense of the first network node utilizing a flexible slot for listening to the test signal as transmitted by the second network node.

Embodiments relating to further details of detecting a change in orientation of the AAS 120b of a second network node 200b as performed by the first network node 200a will now be disclosed with continued reference to FIG. 3.

There might be different ways for the first network node 200a to know that the test signal is transmitted by the second network node 200b. In some embodiments, the test signal comprises an identifier of the second network node 200b. In other examples, the first network node 200a is informed that the second network node 200b is to transmit the test signal and thereby knows that the received test signal originates from the second network node 200b. Therefore, in some embodiments the first network node 200a is configured to perform (optional) step S104.

S104: The first network node 200a obtains information regarding in which flexible slot the test signal is to be transmitted.

The first network node 200a can thereby be informed that the monitoring process is about to start. In some examples, the information in S104 is obtained from the second network node 200b. In other examples, the information in S104 is obtained from a network management system.

There may be different ways in which the test signal can be transmitted by the second network node 200b, and hence be received by the first network node 200a. In some aspects, the test signal is transmitted in different transmit beams. In this way, within the flexible slot, the test signal can be transmitted in several occurrences, with one occurrence in each transmit beam. That is, in some embodiments, several occurrences of the test signal are received within one of the flexible slots, where each of the occurrences has been transmitted in a respective transmit beam in a set of transmit beams 140 from the second network node 200b. In some examples, all occurrences of the test signal are received in one and the same receive beam 130 at an antenna 120a of the first network node 200a. In other examples, different occurrences of the test signal are received in different beams at the antenna 120a of the first network node 200a. The latter could be the case where also the antenna 120a is an AAS.

In some aspects, the several occurrences of the test signal as transmitted in the transmit beams give rise to a unique received power beam pattern at the first network node 200a. This unique received power beam pattern can then be regarded as defining the characteristic spatial signature (that is compared to the reference beam pattern). Hence, in some embodiments, all occurrences of the test signal collectively give rise to the characteristic spatial signature of the test signal, and the characteristic spatial signature of the test signal is estimated from reception of all these occurrences of the test signal in the receive beam 130.

In some examples, the specific power beam pattern is defined by the spatial characteristics of the transmitting and receiving antennas, the relation between the orientations of the transmitting and receiving antennas, and by the radio propagation characteristics between the transmitting and receiving antennas. That is, in some embodiments, the characteristic spatial signature of the test signal is defined by antenna characteristics of the AAS 120b of the second network node 200b, antenna characteristics of the first network node 200a, and radio propagation characteristics between the AAS 120b of the second network node 200b and the antenna 120a of the first network node 200a.

As will be further disclosed below, in some examples, the shift in angular orientation corresponds to a minimum angular difference between the estimated characteristic spatial signature and the reference characteristic spatial signature.

As will be further disclosed below, in other examples, the shift in angular orientation corresponds to a difference between angular location of a signal strength peak in the estimated characteristic spatial signature and angular location of a signal strength peak in the reference characteristic spatial signature.

Aspects of the notification will be disclosed next.

In general terms, depending on the size of the angular offset, different activities can be triggered, such as an alarm or recommendations on further activities. Therefore, in some embodiments, the notification is selected from a set of possible notifications, and which notification to issue depends on how much the estimated characteristic spatial signature of the test signal fails to fulfil the matching criterion.

In some examples, the monitoring process is preceded by an initialization process. Aspects of the initialization process will be disclosed next.

In general terms, the initialization process can be performed for the first network node 200a to obtain, or measure, (and store) the characteristic power pattern of the AAS 120b of the second network node 200b.

Therefore, in some embodiments the first network node 200a is configured to perform (optional) step S102.

S102: The first network node 200a performs an initialization process with the second network node 200b. The initialization process comprises obtaining the reference characteristic spatial signature by receiving a reference test signal from the second network node 200b in another one of the flexible slots and estimating the reference characteristic spatial signature from the reference test signal.

In this, way, during the monitoring process, the first network node 200a can measure the orientation shift compared to the initialization situation. In particular, in some embodiments, the matching criterion pertains to a shift in angular orientation of the estimated characteristic spatial signature with respect to the reference characteristic spatial signature.

Further, the first network node 200a might then issue the notification in S108 when the orientation shift is too large. That is, in some embodiments, the matching criterion fails to be fulfilled when the shift in angular orientation is larger than a threshold value.

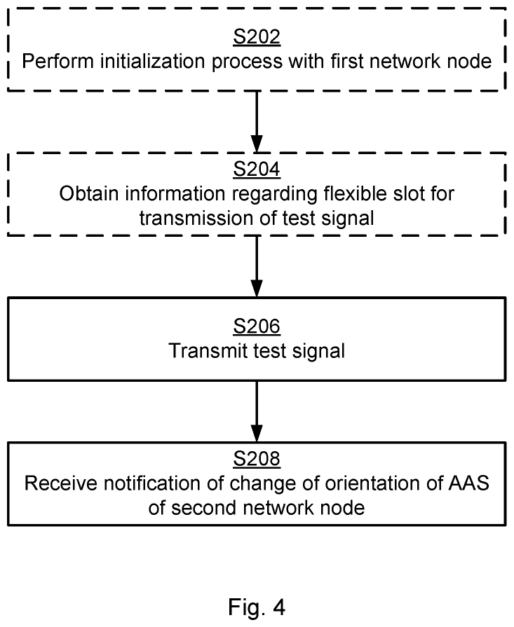

Reference is now made to FIG. 4 illustrating a method for detecting a change in orientation of an AAS 120b of a second network node 200b as performed by the second network node 200b according to an embodiment. The second network node 200b and the first network node 200a are operating in a TDD system 100 with a slot structure composed of DL slots, UL slots, and flexible slots.

S206: The second network node 200b transmits, via the AAS 120b and in one of the flexible slots, a test signal.

S208: The second network node 200b receives a notification of change of orientation of the AAS 120b of the second network node 200b when estimated characteristic spatial signature of the test signal fails to fulfil a matching criterion with respect to a reference characteristic spatial signature of the test signal.

Embodiments relating to further details of detecting a change in orientation of the AAS 120b of a second network node 200b as performed by the second network node 200b will now be disclosed with continued reference to FIG. 4.

As noted above, the test signal can be transmitted in several occurrences, with one occurrence in each transmit beam. Particularly, in some embodiments, several occurrences of the test signal are transmitted within one of the flexible slots. Each of the occurrences is transmitted in a respective transmit beam in a set of transmit beams 140.

There can be different examples of transmit beams. In some examples, all the transmit beams in the set of transmit beams have same beam shape but different pointing directions. In other examples, the beam shape is different for different steering (or pointing) directions). In yet other examples, outer beams are broader than inner beams.

As noted above, reception of several occurrences of the test signal might give rise to a unique received power beam pattern, defining the characteristic spatial signature. That is, in some embodiments, all occurrences of the test signal collectively give rise to the characteristic spatial signature of the test signal.

As noted above, in some embodiments, the test signal comprises an identifier of the second network node 200b.

In some examples, the second network node 200b itself decides that the monitoring process is to be performed. The second network node 200b might then inform the first network node 200a as in S104. However, in other aspects, the second network node 200b is instructed that the monitoring process is to be performed. Therefore, in some embodiments the second network node 200b is configured to perform (optional) step S204.

S204: The second network node 200b obtains information regarding in which flexible slot the test signal is to be transmitted.

In some examples, the information in S204 is obtained from a network management system.

In some aspects, a two-step monitoring process is performed. In a first phase of the monitoring process, the test signal might be transmitted in a set of broad transmit beams whereas in a second phase of the monitoring process, the test signal might be transmitted in a set of narrow transmit beams. That is, in some embodiments, the monitoring process is performed, in yet another one of the flexible slots, for an initial set of transmit beams, wherein the set of transmit beams 140 comprises transmit beams that have a narrower beam shape than the initial set of transmit beams and that have orientations selected to be centred around a shift in angular orientation of the estimated characteristic spatial signature as obtained for the initial set of transmit beams with respect to the reference characteristic spatial signature. In other examples, the beams used in the first phase are as narrow as the beams used in the second phase of the monitoring process.

As noted above, in some examples, the monitoring process is preceded by an initialization process. Aspects of the initialization process will be disclosed next. As noted above, in general terms, the initialization process can be performed for the first network node 200a to obtain, or measure, (and store) the characteristic power pattern of the AAS 120b of the second network node 200b. Therefore, in some embodiments the second network node 200b is configured to perform (optional) step S202.

S202: The second network node 200b performs an initialization process with the first network node 200a. The initialization process comprises transmitting a reference test signal via the AAS 120b in another one of the flexible slots.

During the initialization process, within the flexible slot, the second network node 200b might transmit the reference test signal in several occurrences, with one occurrence of the reference test signal in each transmit beam. That is, in some embodiments, several occurrences of the reference test signal are transmitted within another one of the flexible slots, and each of the occurrences is transmitted in a respective transmit test beam in a set of transmit test beams.

In some embodiments, several occurrences of the reference test signal are transmitted within this another one of the flexible slots, where each of the occurrences is transmitted in a respective transmit test beam in a set of transmit test beams. The set of transmit test beams might be identical to the set of transmit beams in which the test signal is transmitted in S206. Hence, the transmit test beams in the set of transmit test beams might all have the same beam shape but different pointing directions. In other examples, the beam shape is different for different steering (or pointing) directions). In yet other examples, outer beams are broader than inner beams.

As noted above, in some embodiments, all occurrences of the reference test signal collectively give rise to the reference characteristic spatial signature of the test signal.

In some aspects, a two-step initialization process is performed. This two-step initialization process is similar to the above disclosed two-step monitoring process. In particular, in some embodiments, the initialization process is performed, in yet another one of the flexible slots, for an initial set of transmit test beams. The set of transmit test beams comprises transmit test beams that have a narrower beam shape than the initial set of transmit test beams and that have orientations selected to be centred around the transmit test beam in the initial set of transmit test beams for which highest received power is reported.

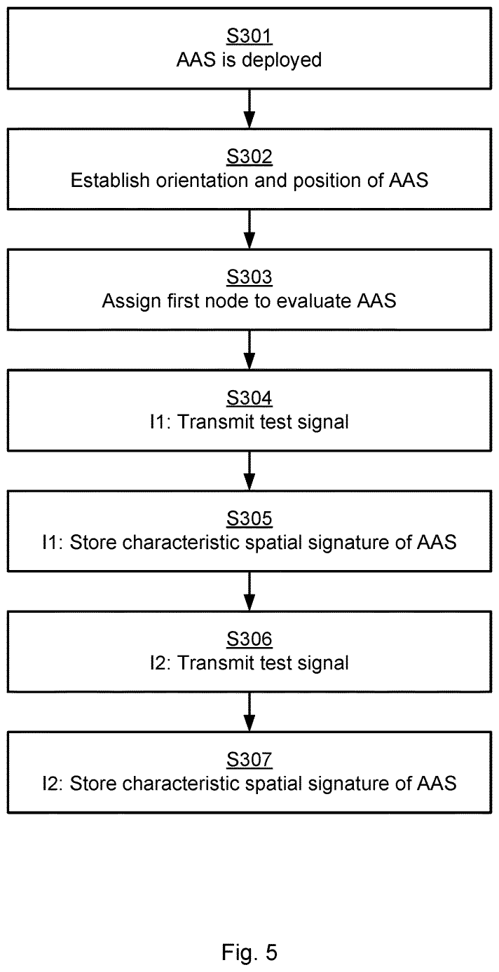

One particular embodiment based on at least some of the above disclosed embodiments for implementing an AAS orientation initialization process during site deployment will now be disclosed in detail with reference to the flowchart of FIG. 5. The network node for which the AAS orientation initialization process is to be performed is denoted a second network node whereas the network node that monitors the AAS of the second network node is denoted a first network node. It is understood that the AAS orientation initialization process can be performed for several pairs of network nodes.

S301: An AAS with ability to use dynamic TDD is deployed at site. An AAS initialization process is started.

S302: Orientation and position of the AAS is established. Values of the orientation and position of the AAS are stored in the second network node and/or in a centralized or distributed network monitoring system.

S303: The first network node is assigned to be used for evaluating the AAS. Which network node to be assigned might for example be based on the smallest inter-site distance, a network node with dynamic TDD functionality enabled, a network node located within specified angular ranges from the AAS boresight in azimuth and elevation planes, signal strength, angular separation, etc.

An initialization process is then run by two actions, hereinafter denoted 11 and 12, being executed.

S304: In action 11, the second network node, via its AAS, transmits a test signal in a traffic beam in directions within specified angular ranges in azimuth and elevation planes. The test signal is transmitted in steps of X1 and X2 degrees in azimuth and elevation, respectively. For each direction, the first network node, using a suitable shaped beam, measures on the test signal. The first network node will thereby estimate the characteristic spatial signature of the AAS as decided by the relation of the positions and orientations between the first network node and the second network node as well as the relation of the specific beam steering of the first network node and the second network node.

S305: In action 11, the first network node stores the characteristic spatial signature of the AAS (e.g., in terms of the received signal as a function of angles ((Y11, Z11), (Y12, Z12), . . . (Y1n, Z1n))) as measured in S304 and/or reports the characteristic spatial signature of the AAS to the network monitoring system, where the network monitoring system then stores the characteristic spatial signature of the AAS.

S306: In action 12, the second network node, via the AAS, again transmits a test signal in a traffic beam in directions within specified angular ranges in azimuth and elevation planes, but this time in steps of X3 and X4 degrees respectively. Here, X3 and X4 are significantly smaller than X1 and X2 and are centred around the detected angle of maximum detected signal strength in azimuth and elevation in action 11. For each direction, the first network node, using a suitable shaped beam, measures on the test signal as in S304.

S307: In action 12, the first network node stores the characteristic spatial signature of the AAS (e.g., in terms of angles ((Y11, Z11), (Y12, Z12), . . . (Y1n, Z1n)) of the maximum detected signal strength) as measured in S306 and/or reports the characteristic spatial signature of the AAS to the network monitoring system, where the network monitoring system then stores the characteristic spatial signature of the AAS.

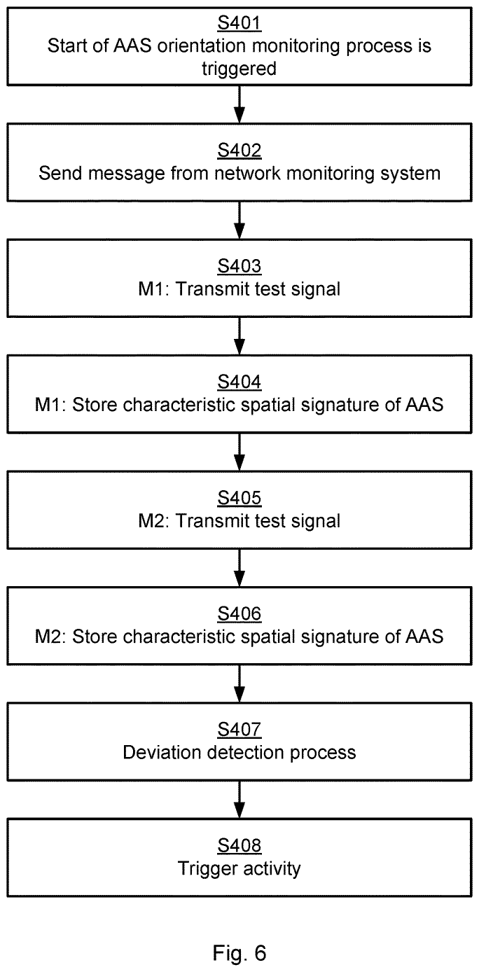

One particular embodiment based on at least some of the above disclosed embodiments for implementing an AAS orientation monitoring process will now be disclosed in detail with reference to the flowchart of FIG. 6. The network node for which the AAS is to be monitored is denoted a second network node whereas the network node that monitors the AAS of the second network node is denoted a first network node. It is understood that the AAS orientation monitoring process can be performed for several pairs of network nodes.

S401: An external event, such as heavy weather in terms of a storm or similar, or the occurrence of a regular inspection interval, triggers the start of the AAS orientation monitoring process.

S402: A message is sent from the network monitoring system to the first network node to start monitoring the AAS of the second network node. A corresponding message is sent from the network monitoring system to the second network node to start transmitting a test signal via its AAS. The first network node and the second network node are thereby made aware of the point in time the AAS orientation. monitoring process is to be initiated.

A monitoring process is then run by two actions, hereinafter denoted M1 and M2, being executed.

S403: In action M1, the second network node, via its AAS, transmits a test signal in a traffic beam in directions within specified angular ranges in azimuth and elevation planes. The test signal is transmitted in steps of X1 and X2 degrees in azimuth and elevation, respectively. For each direction, the first network node, using a suitable shaped beam, measures on the test signal. The first network node will thereby estimate the characteristic spatial signature of the AAS as decided by the relation of the positions and orientations between the first network node and the second network node, optionally also the relation of the specific beam steering of the first network node and the second network node.

S404: In action M1, the first network node stores the characteristic spatial signature of the AAS (e.g., in terms of the received signal as a function of angles ((Y11, Z11), (Y12, Z12), . . . (Y1n, Z1n))) as measured in S403 and/or reports the characteristic spatial signature of the AAS to the network monitoring system, where the network monitoring system then stores the characteristic spatial signature of the AAS.

S405: In action M2, the second network node, via the AAS, again transmits a test signal in a traffic beam in directions within specified angular ranges in azimuth and elevation planes, but this time in steps of X3 and X4 degrees respectively. Here, X3 and X4 are significantly smaller than X1 and X2 and are centred around the detected angle of maximum detected signal strength in azimuth and elevation in action M1. For each direction, the first network node, using a suitable shaped beam, measures on the test signal as in S403.

S406: In action M2, the first network node stores the characteristic spatial signature of the AAS (e.g., in terms of angles ((Y11, Z11), (Y12, Z12), . . . (Y1n, Z1n)) of the maximum detected signal strength) as measured in S405 and/or reports the characteristic spatial signature of the AAS to the network monitoring system, where the network monitoring system then stores the characteristic spatial signature of the AAS S407: In a deviation detection process, the characteristic spatial signature of the AAS from action 12 and the characteristic spatial signature of the AAS from action M2 are compared. The deviation detection is based on modelling the impact of a hypothetical angular offset (of the transmitting antenna) on the detected signal signature in action M2. By comparing which hypothetical angular offset gives the best fit with the signature from action 12, this offset can be determined. When modelling the impact of a hypothetical angular shift, the expected angular variation of the transmitted beams can be compensated for. This is since the type of transmitting antenna is known.

S408: Depending on size of the angular offset, different activities can be triggered, such as an alarm or recommendations on further activities for further controlling the AAS of the second network node.

Further embodiments, aspects, and illustrative examples will be disclosed next.

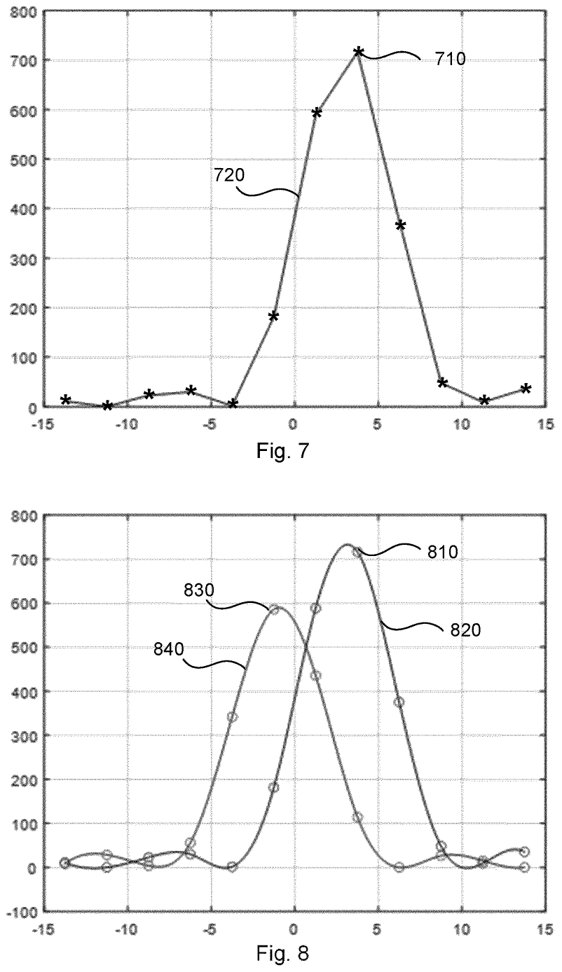

During the initialization phase, the AAS of the second network node might be assumed to have a nominal orientation. An example of the signal power received by the first network node is shown below in FIG. 7. Twelve individual measurements points 710, each corresponding to transmission of the test signal in one beam, are shown by “*” and the individual measurements points can be joined together to form a certain pattern, as shown by solid lines 720 connecting the individual measurements points. In further detail, the transmitted beam direction, relative to the boresight of the transmitting AAS, is on the horizontal (x) axis. In this example, the first network node is located at 3.1° and the separation between the beams in which the test signal is transmitted is 2.5°. On the vertical (y) axis is shown the received signal power at the first network node.

Under line-of-sight channel conditions and high signal to noise ratio (SNR) conditions, the peak (i.e., the measurement point with the highest received signal power) will simply appear at the angle towards the first network node (i.e., at 3.1° for the present example). The peak can be accurately extracted by interpolating the individual measurements points. An example interpolation pattern 820 for the same twelve individual measurements points 810 as in FIG. 7 is shown in FIG. 8. This yields the direction towards the first network node in the local coordinate system of the AAS, and from this the orientation of the AAS can be calculated (assuming that the positions of the first network node and the second network node are known).

If the orientation of the AAS is changed (whilst the line-of-sight and high SNR conditions still are fulfilled), the new orientation angle can be readily obtained from the new peak location. An example of individual measurements points 830 resulting from the orientation of the AAS having been shifted by −4° is shown in FIG. 8, together with the corresponding interpolation pattern 840. The power level is assumed to be altered by an arbitrary amount between initialization and measurement due to hardware or channel properties outside control.

Under non-line-of-sight channel conditions, the situation is different. Assume that the same first network node is still located at 3.1° with respect to the boresight direction of the AAS of the second network node but that the wireless propagation channel is dominated by two (equally strong) non-line-of-sight paths in directions 3.2° and 4.8°. Assume further that the orientation of the AAS becomes shifted by −4°. Obviously, the peak will now point in a different direction (around 4°) than that towards the first network node. However, the main goal is still to estimate the orientation shift compared to the initialization situation and this can still be done. One way to accomplish this is to take the different between the peak locations. Another way to accomplish this is to search for the shift Δφ that minimizes some measure of the difference Δs between the two interpolation patterns:

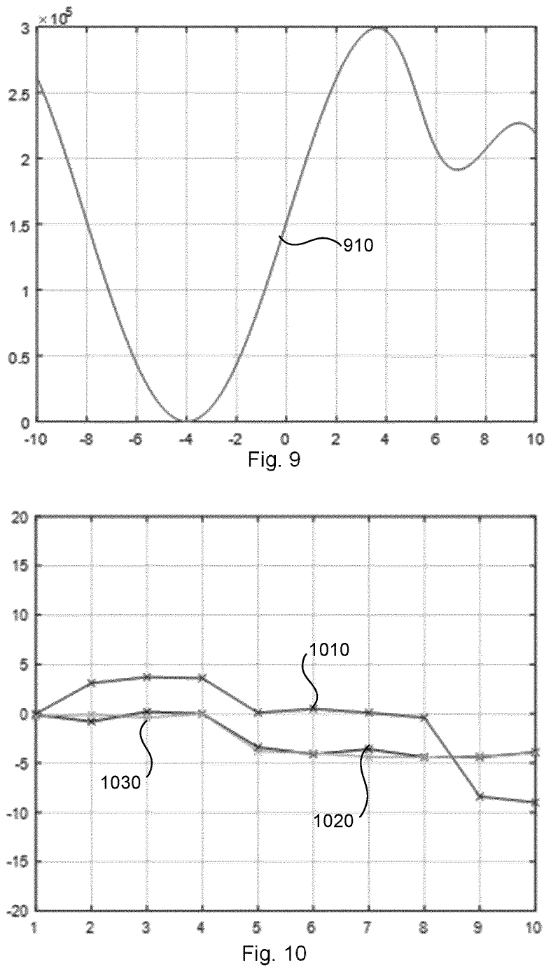

Δφ=argmin(Δs(Δφ))

where, for example

$$Δ s ( Δφ ) = {min}_{a} \frac{\sum {{w}_{i} ( D {s}_{1} ( Δφ ) - a {s}_{0} )}^{2}}{\sum {w}_{i}}$$

where Ds₁ is a shifted version of the interpolated signal power, s₁, at the monitoring phase and s₀ is the interpolated signal power in the initialization phase, wᵢ is a weight function, e.g., take to be equal to s₁, and a is accounting for an unknown change in signal strength. The argument Δφ that minimizes Δs provides the estimated shift of the orientation of the AAS. The difference Δs(Δφ) for the example case is shown as the curve 910 in FIG. 9. The cost function as given by the parameter Δs as used above is not optimized. A maximum likelihood algorithm can be used to derive an optimum cost function.

In some aspects, it is assumed that the wireless propagation channels between the network nodes to some extent are stable over time. This is expected to be the case since the locations of the network nodes, and hence, the AASs are fixed. Some fast-fading behavior of the wireless propagation channel may still be present. The impact of such behavior on the disclosed techniques for detecting a change in the orientation of the AAS can be mitigated, reduced, or even be overcome, by averaging. A small change of the wireless propagation channel may also occur as a result of a rotation of the AAS. This can somewhat affect the ability to accurately measure the rotation angle but will not affect the ability to detect that a rotation has occurred. It can also be that, for some reason, that the wireless propagation channel between one antenna of the AAS at one network node and one antenna of the AAS at another network node is unstable, e.g., due to that this wireless propagation channel is dominated by reflections from moving objects. However, this is expected to be unlikely, and the impact of this can be mitigated, reduced, or even be overcome, by having more than one network node performing measurements on the test signals. An illustration of this is shown in FIG. 10. In the example of FIG. 10 is show how estimations 1010, 1020, 1030 of the rotation of one AAS changes over time (as defined by 10 points along the horizontal (x) axis). Estimations from measurements made at three network nodes receiving test signals are shown. It can be seen that the estimations 1020, 1030 from two of the network nodes are quite similar, whereas one estimation 1010 shows unstable behavior.

In the examples above an AAS with an antenna array composed of 16-by-16 antenna elements with an antenna element spacing of 0.5λ was used, with an operating frequency of 28 GHz. However, the herein disclosed embodiments are not limited to any particular configuration of the AAS or to any particular operating frequency.

For example, the herein disclosed embodiments are also applicable to AASs having sub-array structures. Further, it is not necessary that the AAS of all participating network nodes have the same structure. The array geometries of the different AASs in the network are assumed to be known and this information can be used in the processing.

It is here noted that although it has above been disclosed that, during the monitoring process, the test signal is transmitted from the network node to be tested, i.e., from the second network node 200b, and received by at least one testing network node, i.e., by at least one first network node 200a, it is also possible that the test signal is transmitted by the testing network node, i.e., by at least one first network node 200a, and received by the network node to be tested, i.e., by the second network node 200b. In this way, the second network node 200b would perform e.g., S106, whereas the at least one first network node 200a would perform e.g., S206. In other words, this would imply that the roles of transmitting and receiving test signals would be reversed during the monitoring process, but that the end-result would still be the same, namely that the second network node 200b is the network node that for which a change in orientation of the AAS 120b is detected. This could also include the transmission and reception of test signals during the initialization process.

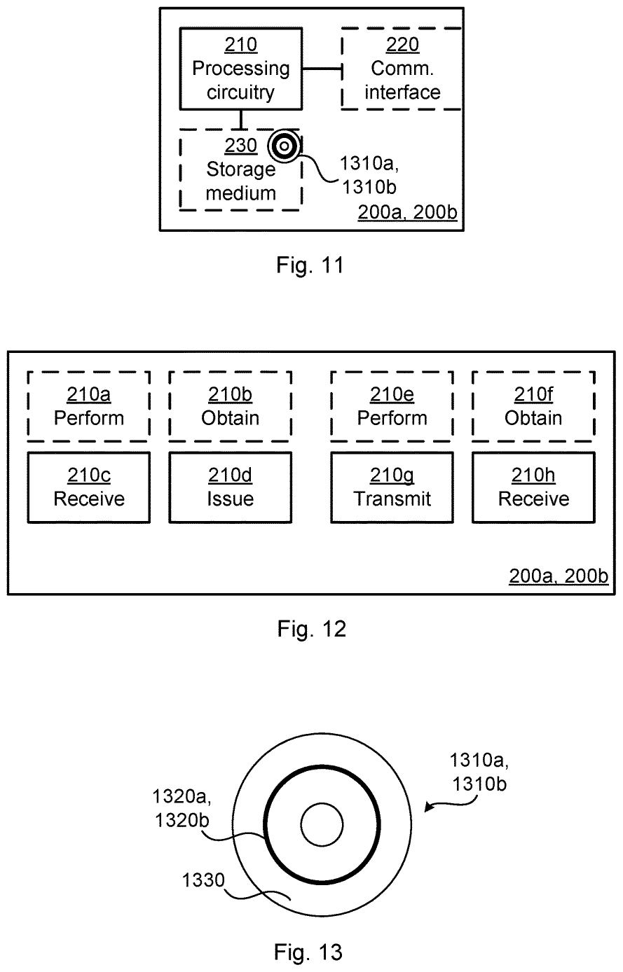

FIG. 11 schematically illustrates, in terms of a number of functional units, the components of a network node 200a, 200b configured as a first network node 200a and/or a second network node 200b according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1310a (as in FIG. 13), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200a, 200b to perform a set of operations, or steps, as disclosed above. For example, the storage medium 230 may store the set of operations, and the processing circuitry 210 may be configured to retrieve the set of operations from the storage medium 230 to cause the network node 200a, 200b to perform the set of operations. The set of operations may be provided as a set of executable instructions. Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200a, 200b may further comprise a communications (comm.) interface 220 for communications with other entities, functions, nodes, and devices, as in FIG. 1. As such the communications interface 220 may comprise one or more transmitters and receivers, comprising analogue and digital components. For example, the communications interface 220 may comprise one or more AAS 120a, 120b.

The processing circuitry 210 controls the general operation of the network node 200a, 200b e.g. by sending data and control signals to the communications interface 220 and the storage medium 230, by receiving data and reports from the communications interface 220, and by retrieving data and instructions from the storage medium 230. Other components, as well as the related functionality, of the network node 200a, 200b are omitted in order not to obscure the concepts presented herein.

FIG. 12 schematically illustrates, in terms of a number of functional modules, the components of a network node 200a, 200b according to an embodiment.

The network node 200a, 200b when configured as the first network node 200a comprises a number of functional modules; a receive module 210c configured to perform step S106, and an issue module 210d configured to perform step S108. The network node 200a, 200b when configured as the first network node 200a may further comprise a number of optional functional modules, such as any of a perform module 210a configured to perform step S102, and an obtain module 210b configured to perform step S104.

The network node 200a, 200b when configured as the second network node 200b comprises a number of functional modules; a transmit module 210g configured to perform step S206, and a receive module 210h configured to perform step S208. The network node 200a, 200b when configured as the second network node 200b may further comprise a number of optional functional modules, such as any of a perform module 210e configured to perform step S202, and an obtain module 210f configured to perform step S204.

In general terms, each functional module 210a:210h may be implemented in hardware or in software. Preferably, one or more or all functional modules 210a:210h may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210h and to execute these instructions, thereby performing any steps of the network node 200a, 200b as disclosed herein.

The network node 200a, 200b may be provided as a standalone device or as a part of at least one further device. For example, the network node 200a, 200b may be provided in a node of the radio access network or in a node of the core network. Alternatively, functionality of the network node 200a, 200b may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200a, 200b may be executed in a first device, and a second portion of the instructions performed by the network node 200a, 200b may be executed in a second device; the herein disclosed embodiments are not limited to any particular number of devices on which the instructions performed by the network node 200a, 200b may be executed. Hence, the methods according to the herein disclosed embodiments are suitable to be performed by a network node 200a, 200b residing in a cloud computational environment. Therefore, although a single processing circuitry 210 is illustrated in FIG. 11 the processing circuitry 210 may be distributed among a plurality of devices, or nodes. The same applies to the functional modules 210a:210h of FIG. 12 and the computer programs 1320a, 1320b of FIG. 13.

Some (radio) access network architectures define network nodes (or gNBs) comprising multiple component parts or nodes: a central unit (CU), one or more distributed units (DUs), and one or more radio units (RUs). The protocol layer stack of the network node is divided between the CU, the DUs and the RUs, with one or more lower layers of the stack implemented in the RUs, and one or more higher layers of the stack implemented in the CU and/or DUs. The CU is coupled to the DUs via a fronthaul higher layer split (HLS) network; the CU/DUs are connected to the RUs via a fronthaul lower-layer split (LLS) network. The DU may be combined with the CU in some embodiments, where a combined DU/CU may be referred to as a CU or simply a baseband unit. A communication link for communication of user data messages or packets between the RU and the baseband unit, CU, or DU is referred to as a fronthaul network or interface. Messages or packets may be transmitted from the network node 200a, 200b in the downlink (i.e., from the CU to the RU) or received by the network node 200a, 200b in the uplink (i.e., from the RU to the CU).

FIG. 13 shows one example of a computer program product 1310a, 1310b comprising computer readable means 1330. On this computer readable means 1330, a computer program 1320a can be stored, which computer program 1320a can cause the processing circuitry 210 and thereto operatively coupled entities and devices, such as the communications interface 220 and the storage medium 230, to execute methods according to embodiments described herein. The computer program 1320a and/or computer program product 1310a may thus provide means for performing any steps of the first network node 200a as herein disclosed. On this computer readable means 1330, a computer program 1320b can be stored, which computer program 1320b can cause the processing circuitry 310 and thereto operatively coupled entities and devices, such as the communications interface 320 and the storage medium 330, to execute methods according to embodiments described herein. The computer program 1320b and/or computer program product 1310b may thus provide means for performing any steps of the second network node 200b as herein disclosed.

In the example of FIG. 13, the computer program product 1310a, 1310b is illustrated as an optical disc, such as a CD (compact disc) or a DVD (digital versatile disc) or a Blu-Ray disc. The computer program product 1310a, 1310b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory.

Thus, while the computer program 1320a, 1320b is here schematically shown as a track on the depicted optical disk, the computer program 1320a, 1320b can be stored in any way which is suitable for the computer program product 1310a, 1310b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for detecting a change in orientation of an active antenna system (AAS) of a second network node, wherein the method is performed by a first network node, wherein the second network node and the first network node are operating in a time-division duplex (TDD) system with a slot structure composed of downlink (DL) slots, uplink (UL) slots, and flexible slots, wherein the method comprises a monitoring process, and wherein the monitoring process comprises:
receiving, in one of the flexible slots and from the second network node, a test signal, wherein receiving the test signal involves estimating a characteristic spatial signature of the test signal; and
issuing a notification of change of orientation of the AAS of the second network node when the estimated characteristic spatial signature of the test signal fails to fulfil a matching criterion with respect to a reference characteristic spatial signature of the test signal.

2. The method of claim 1, wherein
several occurrences of the test signal are received within said one of the flexible slots, wherein each of the occurrences has been transmitted in a respective transmit beam in a set of transmit beams from the second network node.

3. The method of claim 2, wherein
all occurrences of the test signal collectively give rise to the characteristic spatial signature of the test signal, and wherein the characteristic spatial signature of the test signal is estimated from reception of said all occurrences of the test signal in the receive beam.

4. The method of claim 2, wherein
the characteristic spatial signature of the test signal is defined by antenna characteristics of the AAS of the second network node, antenna characteristics of the first network node, and radio propagation characteristics between the AAS of the second network node and the antenna of the first network node.

5. The method of claim 1, wherein
the test signal comprises an identifier of the second network node.

6. The method of claim 1, wherein
the method further comprises:
obtaining information regarding in which flexible slot the test signal is to be transmitted.

7. The method of claim 1, wherein
the method further comprises:
performing an initialization process with the second network node, the initialization process comprising obtaining the reference characteristic spatial signature by receiving a reference test signal from the second network node in another one of the flexible slots and estimating the reference characteristic spatial signature from the reference test signal.

8. The method of claim 1, wherein
the matching criterion pertains to a shift in angular orientation of the estimated characteristic spatial signature with respect to the reference characteristic spatial signature.

9-11. (canceled)

12. The method of claim 1,
wherein the notification is selected from a set of possible notifications, and wherein which notification to issue depends on how much the estimated characteristic spatial signature of the test signal fails to fulfil the matching criterion.

13. A method for detecting a change in orientation of an active antenna system, (AAS) of a second network node, wherein the method is performed by the second network node, wherein the second network node and a first network node are operating in a time-division duplex (TDD) system with a slot structure composed of downlink (DL) slots, uplink (UL) slots, and flexible slots, wherein the method comprises a monitoring process, and wherein the monitoring process comprises:
transmitting, via the AAS and in one of the flexible slots, a test signal; and
receiving a notification of change of orientation of the AAS of the second network node when estimated characteristic spatial signature of the test signal fails to fulfil a matching criterion with respect to a reference characteristic spatial signature of the test signal.

14. The method of claim 13, wherein
several occurrences of the test signal are transmitted within said one of the flexible slots, and wherein each of the occurrences is transmitted in a respective transmit beam in a set of transmit beams.

15-16. (canceled)

17. The method of claim 13, wherein
the test signal comprises an identifier of the second network node.

18. The method of claim 13, wherein
the method further comprises:
obtaining information regarding in which flexible slot the test signal is to be transmitted.

19. The method of claim 13, wherein
the monitoring process is performed, in yet another one of the flexible slots, for an initial set of transmit beams, wherein the set of transmit beams comprises transmit beams that have a narrower beam shape than the initial set of transmit beams and that have orientations selected to be centred around a shift in angular orientation of the estimated characteristic spatial signature as obtained for the initial set of transmit beams with respect to the reference characteristic spatial signature.

20. The method of claim 13, wherein
the method further comprises:
performing an initialization process with the first network node, the initialization process comprising transmitting a reference test signal via the AAS in another one of the flexible slots.

21-23. (canceled)

24. The method of claim 13, wherein
the initialization process is performed, in yet another one of the flexible slots, for an initial set of transmit test beams, wherein the set of transmit test beams comprises transmit test beams that have a narrower beam shape than the initial set of transmit test beams and that have orientations selected to be centred around the transmit test beam in the initial set of transmit test beams for which highest received power is reported.

25. A first network node for detecting a change in orientation of an active antenna system, AAS, of a second network node, wherein the method is performed by a first network node, wherein the second network node and the first network node are operating in a time-division duplex (TDD) system with a slot structure composed of downlink (DL) slots, uplink (UL) slots, and flexible slots, the first network node comprising processing circuitry, the processing circuitry being configured to cause the first network node to:
receive, in one of the flexible slots and from the second network node, a test signal, wherein receiving the test signal involves estimating a characteristic spatial signature of the test signal; and
issue a notification of change of orientation of the AAS of the second network node when the estimated characteristic spatial signature of the test signal fails to fulfil a matching criterion with respect to a reference characteristic spatial signature of the test signal.

26-27. (canceled)

28. A second network node for detecting a change in orientation of an active antenna system (AAS) of the second network node, wherein the second network node and a first network node are operating in a time-division duplex (TDD) system with a slot structure composed of downlink (DL) slots, uplink (UL) slots, and flexible slots, the second network node comprising processing circuitry, the processing circuitry being configured to cause the second network node to:
transmit, via the AAS and in one of the flexible slots, a test signal; and
receive a notification of change of orientation of the AAS of the second network node when estimated characteristic spatial signature of the test signal fails to fulfil a matching criterion with respect to a reference characteristic spatial signature of the test signal.

29-33. (canceled)
